(19) United States
(12) Patent Application Publication
(10) Pub. No.: US 2009/0271578 A1
(43) Pub. Date: Oct. 29, 2009

(54) Reducing Memory Fetch Latency Using Next Fetch Hint

(76) Inventors: Wayne M. Barrett, Rochester, MN (US); Brian T. Vanderpool, Byron, MN (US)

Correspondence Address: IBM Corporation;Intellectual Property Law Dept. 917, 3605 Hwy. 52 North, Rochester, MN, 55901, US

(21) Appl. No.: 12/108,019

(22) Filed: Apr. 23, 2008

(51) Int. Cl. G06F 12/00

(52) U.S. Cl. 711/154; 711/E12.001

(57) ABSTRACT

In one aspect, a processor is provided. The processor may include logic, coupled to the processor, and to issue a currently issued memory fetch over a processor bus. The currently issued memory fetch may include a next fetch hint that may include information about a next memory fetch.

### FIELD OF THE INVENTION

The present invention relates generally to reducing memory fetch latency and, more particularly, to methods and apparatus for reducing memory fetch latency using a next fetch hint.

### BACKGROUND THE INVENTION

In a typical bus-based computer system, one or more processors may be connected to a memory controller. The one or more processors and the memory controller may be connected with shared or point to point busses. That is, generally speaking, a processor may be connected to a memory controller via a processor bus.

Internal processor frequencies are commonly reaching 2 GHz, with some running over 5 GHz. However, due to electrical limitations, it is not possible to run the interface (i.e., a processor bus) between a processor and a memory controller at such a high rate of speed. For example, for a non-serial processor bus, a data rate of 1000 MT/s is approaching the limit of what can be signaled. As such, the processor bus can be a bottleneck in bandwidth intensive applications, such as STREAM, SPECfp/SPECint, or SPECjbb.

Due to the rate of signaling for data returns, the rate at which commands may be issued on a processor bus may be limited. For instance, on a quad pumped processor bus, a request may be issued once every two cycles, so when reading from memory, the request rate may not exceed the maximum data bandwidth.

Internally generated requests by a processor may therefore be queued up inside the processor, waiting for their time to gain access to the processor bus. Work has been done in the past to prioritize prefetch reads versus actual reads, but given how fast processor cores are becoming, by the time a prefetch read reaches a processor bus queue, it may have morphed into a demand read, and any delay by the memory controller in processing the read may impact system performance.

### SUMMARY OF THE INVENTION

In a first aspect of the invention, a processor may be provided. The processor may include logic, coupled to the processor, and to issue a currently issued memory fetch over a processor bus. The currently issued memory fetch may include a next fetch hint that may include information about a next memory fetch.

In a second aspect of the invention, a memory controller may be provided. The memory controller may include logic, coupled to the controller, and to receive a currently issued memory fetch. The currently issued memory fetch may include a next fetch hint including information about a next memory fetch. The memory controller may begin a memory access corresponding to the next memory fetch before the next memory fetch is received by the memory controller.

In a third aspect of the invention, a system may be provided. The system may include a processor, a memory controller, a processor bus to connect the processor to the memory controller, and logic. The logic may be coupled to the processor, and may issue a currently issued memory fetch from the processor to the memory controller over the processor bus. The currently issued memory fetch may include a next fetch hint including information about a next memory fetch.

In a fourth aspect of the invention, a method may be provided. The method may include issuing a currently issued memory fetch from a processor to a memory controller over a processor bus. The currently issued memory fetch may include a next fetch hint including information about a next memory fetch.

Other features and aspects of the present invention will become more fully apparent from the following detailed description, the appended claims, and the accompanying drawings.

### BRIEF DESCRIPTION OF THE FIGURES

FIG. 1 is a block diagram of a bus-based system in accordance with an embodiment of the present invention;

FIG. 2 is a schematic representation of a bus request in accordance with an embodiment of the present invention;

FIG. 3 illustrates a method for reducing memory fetch latency using a next fetch hint in accordance with an embodiment of the present invention;

FIG. 4A is a schematic representation of commands within a processor bus queue according to an embodiment of the present invention; and

FIG. 4B is a schematic representation of a request stream of a processor according to an embodiment of the present invention.

### DETAILED DESCRIPTION

What is needed is a method to allow a memory controller to be able to view a processor bus queue, to begin processing of a memory fetch that may be issued, prior to its issuance on the processor bus. An embodiment of the present invention may provide a method for a processor to communicate information about a next memory fetch it may issue as part of a currently issued memory fetch (i.e., bus request). This may allow a memory controller to begin the next memory fetch while the next memory fetch may still be in the processor bus queue, and prior to its issuance on the processor bus. When the next memory fetch is then issued, a memory access (e.g., DRAM access) has already commenced, and the data may be returned with reduced latency. The information about the next memory fetch may be referred to as a next fetch hint.

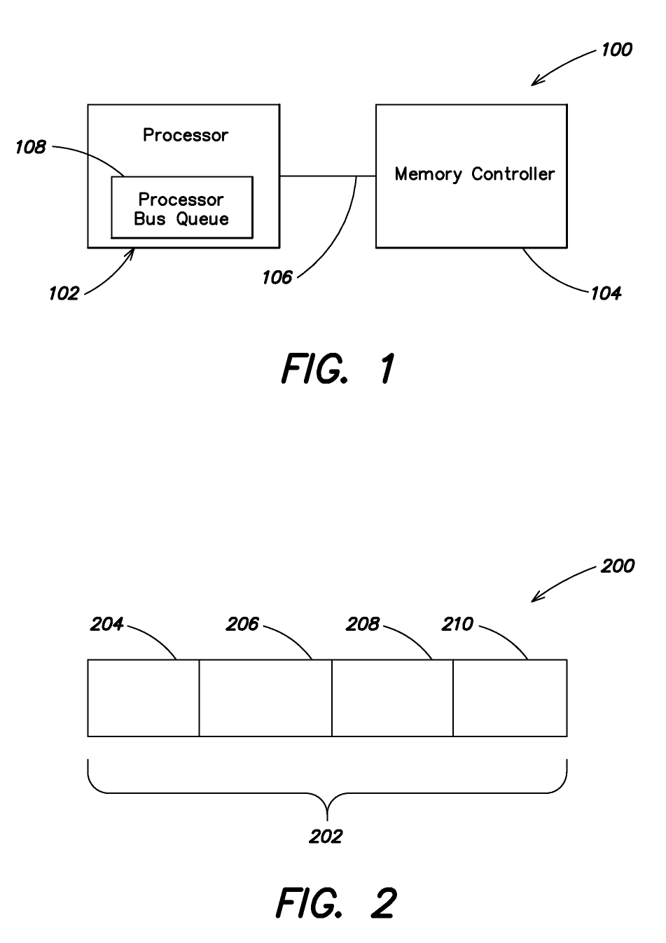

FIG. 1 is a block diagram of a bus-based system 100 in accordance with an embodiment of the present invention. The bus-based system 100 may include a processor 102 connected to a memory controller 104 via a processor bus 106. The processor 102 may include a processor bus queue 108.

FIG. 2 is a schematic representation of a bus request 200 in accordance with an embodiment of the present invention. In a standard bus-based signaling protocol, a bus request 200 may consist of a request phase 202, during which an address 204, request type 206, and other attributes 208 may be driven by an agent (e.g., the processor 102) on the bus (e.g., the processor bus 106). All other slave agents on the bus may perform a snoop of their caches/directories, and report snoop results. The snoop results may be gathered by a central agent (e.g., the memory controller 104) and the results may be signaled during a response phase (not shown).

In an embodiment, the processor bus 106 may be a quad pumped data bus. In a quad pumped data bus, bus requests 200 may be issued once every other cycle, and may queue up inside the processor bus queue 108, waiting for their time slice on the processor bus 106. The presence of other requesters on the processor bus 106 may cause further queuing within the processor bus queue 108.

In an embodiment, the processor 102 may examine a next queued request (e.g., a next memory fetch) in the processor bus queue 108, and provide a next fetch hint 210 as part of a currently issued memory fetch (i.e., bus request 200). The next fetch hint 210 may indicate the address of the next memory fetch.

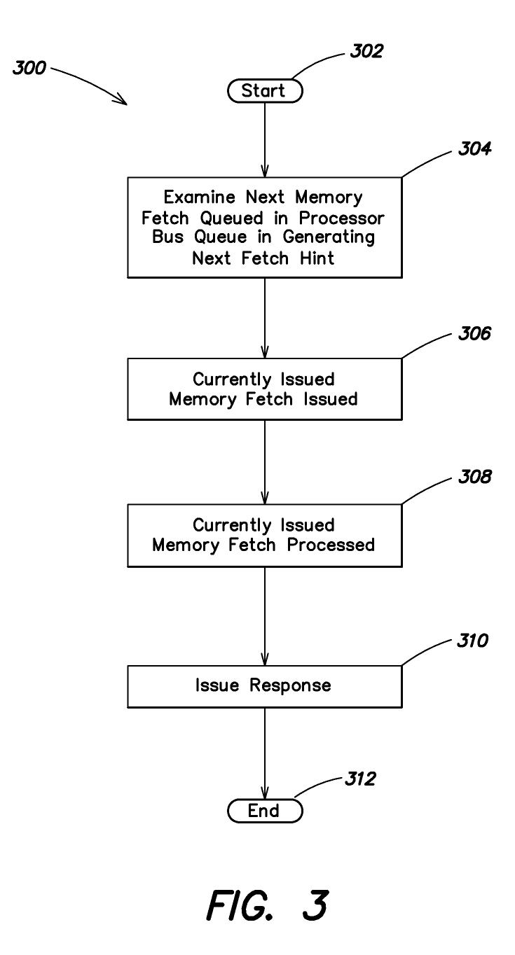

The operation of the bus-based system 100 is now described with reference to FIGS. 1 and 2, and with reference to FIG. 3 which illustrates a method 300 for reducing memory fetch latency using a next fetch hint in accordance with an embodiment of the present invention. With reference to FIG. 3, in operation 302, the method may begin. In operation 304, a next memory fetch queued in the processor bus queue 108 may be examined in generating the next fetch hint 210. In operation 306, the currently issued memory fetch (i.e., bus request 200) may be issued from the processor 102 to the memory controller 104 over the processor bus 106. The currently issued memory fetch may include the next fetch hint 210. The next fetch hint 210 may include information about a next memory fetch. In operation 308, the currently issued memory fetch may be processed by the memory controller 104. The processing of the currently issued memory fetch may include beginning a memory access corresponding to the next memory fetch before the next memory fetch is received by the memory controller. The beginning of the memory access corresponding to the next memory fetch may be in response to the next fetch hint 210. In operation 310, a response may be issued from the memory controller 104 to the processor 102.

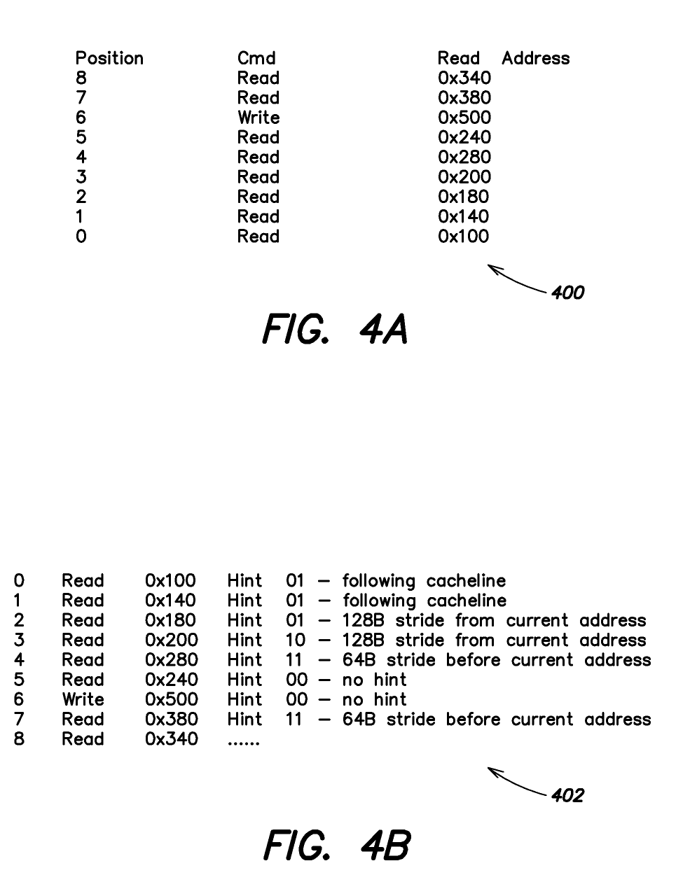

In an embodiment, to take advantage of streaming applications, or “adjacent sector” prefetch behavior of the processor 102, the next fetch hint may be a limited subset of next possible fetches. For example, if two bits of the request phase 202 were used as the next fetch hint 210, the possible combinations could be (assuming a 64 KB cacheline): 00—No next fetch hint; 01—the next bus request may be to the following 64 B cacheline; 10—the next bus request may be to the following 128 B cacheline; and 11—the next bus request may be to the previous 64 B cacheline. FIG. 4A is a schematic representation of commands 400 within the processor bus queue 108 showing application of such a next fetch hint convention. FIG. 4B is a schematic representation of a request stream 402 of the processor 102.

In FIG. 4A, each of the commands 400 is represented with a position, the command itself, and an address. For example, at position 0, there may be a read command to read from address 0x100. At position 1, there may be a read command to read from address 0x140. In FIG. 4B, each request may include a position, a command, an address, and a next fetch hint. For example, for the command at position 0, the command may be to read from address 0x100 and the next fetch hint may be 01 (i.e., to the following cacheline). For the command at position 1, the command may be to read from address 0x140 and the next fetch hint may be 01 (i.e., to the following cacheline).

The memory controller 104 may use the next fetch hint 214 to manipulate the address of the current bus request 200, and issue a subsequent request of the new address to memory prior to the processor 102 actually issuing its request (e.g., next memory fetch). Then, when the processor 102 does issue its request, the request may be matched with the already in-flight memory (e.g., DRAM) access, resulting in a lower latency for the second request.

The foregoing description discloses only exemplary embodiments of the invention. Modifications of the above-disclosed embodiments of the present invention of which fall within the scope of the invention will be readily apparent to those of ordinary skill in the art. For instance, although embodiments are described with reference to environments including a processor bus, in alternative embodiments, environments may include a process bus interface and/or network protocol. Further, although the next fetch hint 210 is described as two-bits of the request phase 202, a larger or smaller number of bits could be used. Similarly, a larger or smaller number of possible next fetch hints could be possible.

Accordingly, while the present invention has been disclosed in connection with exemplary embodiments thereof, it should be understood that other embodiments may fall within the spirit and scope of the invention as defined by the following claims.

The invention claimed is:

1. A processor, comprising:
logic, coupled to the processor, and to issue a currently issued memory fetch over a processor bus,
wherein the currently issued memory fetch comprises a next fetch hint comprising information about a next memory fetch.

2. The processor of claim 1, further comprising:
a processor bus queue; and
logic, coupled to the processor, and to examine the next memory fetch queued in the processor bus queue to generate the next fetch hint.

3. The processor of claim 1, wherein the information about the next memory fetch comprises an address of the next memory fetch.

4. The processor of claim 3, wherein the address of the next memory fetch is relative to an address of the currently issued memory fetch.

5. The processor of claim 4, wherein the address of the next memory fetch is one of a limited subset of possible addresses.

6. The processor of claim 4, wherein the address of the next memory fetch comprises at least one member of the group consisting of no fetch hint, next memory fetch is to a first following cacheline, next memory fetch is to a second following cacheline, and next memory fetch is to a previous cacheline.

7. A memory controller, comprising:
logic, coupled to the controller, and to receive a currently issued memory fetch,
wherein the currently issued memory fetch comprises a next fetch hint comprising information about a next memory fetch, and
wherein the memory controller begins a memory access corresponding to the next memory fetch before the next memory fetch is received by the memory controller.

8. The memory controller of claim 7, wherein the information about the next memory fetch comprises an address of the next memory fetch.

9. The memory controller of claim 8, wherein the address of the next memory fetch is relative to an address of the currently issued memory fetch.

10. The memory controller of claim 9, wherein the address of the next memory fetch is one of a limited subset of possible addresses.

11. The memory controller of claim 9, wherein the address of the next memory fetch comprises at least one member of the group consisting of no fetch hint, next memory fetch is to a first following cacheline, next memory fetch is to a second following cacheline, and next memory fetch is to a previous cacheline.

12. A system, comprising:
a processor;
a memory controller;
a processor bus to connect the processor to the memory controller; and
logic, coupled to the processor, and to issue a currently issued memory fetch from the processor to the memory controller over the processor bus,
wherein the currently issued memory fetch comprises a next fetch hint comprising information about a next memory fetch.

13. The system of claim 12, further comprising:
a processor bus queue; and
logic, coupled to the processor, and to examine the next memory fetch queued in the processor bus queue to generate the next fetch hint.

14. The system of claim 12, wherein the information about the next memory fetch comprises an address of the next memory fetch.

15. The system of claim 14, wherein the address of the next memory fetch is relative to an address of the currently issued memory fetch.

16. The system of claim 15, wherein the address of the next memory fetch is one of a limited subset of possible addresses.

17. The system of claim 15, wherein the address of the next memory fetch comprises at least one member of the group consisting of no fetch hint, next memory fetch is to a first following cacheline, next memory fetch is to a second following cacheline, and next memory fetch is to a previous cacheline.

18. The system of claim 12, wherein the currently issued memory fetch is received by the memory controller, and wherein the memory controller begins a memory access corresponding to the next memory fetch before the next memory fetch is received by the memory controller.

19. A method, comprising:
issuing a currently issued memory fetch from a processor to a memory controller over a processor bus,
wherein the currently issued memory fetch comprises a next fetch hint comprising information about a next memory fetch.

20. The method of claim 19, further comprising examining the next memory fetch queued in a processor bus queue of the processor to generate the next fetch hint.

21. The method of claim 19, wherein the information about the next memory fetch comprises an address of the next memory fetch.

22. The method of claim 21, wherein the address of the next memory fetch is relative to an address of the currently issued memory fetch.

23. The method of claim 22, wherein the address of the next memory fetch is one of a limited subset of possible addresses.

24. The method of claim 22, wherein the address of the next memory fetch comprises at least one member of the group consisting of no next fetch hint, next memory fetch is to a first following cacheline, next memory fetch is to a second following cacheline, and next memory fetch is to a previous cacheline.

25. The method of claim 19, further comprising:
receiving the currently issued memory fetch in the memory controller; and
beginning a memory access corresponding to the next memory fetch before the next memory fetch is received by the memory controller,
wherein the beginning a memory access corresponding to the next memory fetch is in response to the received next fetch hint.
